(19) United States
(12) Patent Application Publication
(10) Pub. No.: US 2017/0109439 A1
(43) Pub. Date: Apr. 20, 2017

(54) DOCUMENT CLASSIFICATION BASED ON MULTIPLE META-ALGORITHMIC PATTERNS

(71) Applicant: Hewlett-Packard Development Company, L.P., Ft. Collins, CO (US)

(72) Inventors: Steven J. Simske, Ft. Collins, CO (US); Marie Vans, Ft. Collins, CO (US); Malgorzata M. Stugill, Ft. Collins, CO (US)

(21) Appl. No.: 15/316,052

(22) PCT Filed: Jun. 3, 2014
(86) PCT No.: PCT/US2014/040620

§ 371 Date: Dec. 2, 2016

(51) Int. Cl. G06F 17/30

(52) U.S. Cl. CPC G06F 17/30719

(57) ABSTRACT

One example is a system including a plurality of summarization engines, a plurality of meta-algorithmic patterns, an extractor, and an evaluator. Each of the plurality of summarization engines receives a text document to provide a meta-summary of the text document. The extractor extracts at least one summarization term from the meta-summary. The extractor generates at least one class term for each given class of a plurality of classes of documents, the at least one class term extracted from documents in the given class. The evaluator determines similarity measures of the text document over each given class of documents of the plurality of classes, each similarity measure indicative of a similarity between the at least one summarization term and the at least one class term for each given class. The selector selects a class of the plurality of classes, the selecting based on he determined similarity measures.

### BACKGROUND

Summarizers are computer-based applications that provide a summary of some type of content, such as text. Meta-algorithms are computer-based designs and their associated applications that can be applied to combine two or more summarizers to yield meta-summaries. Meta-summaries may be used in a variety of applications, including document classification.

### BRIEF DESCRIPTION OF THE DRAWINGS

FIG. 1 is a functional block diagram illustrating one example of a system for document classification based on multiple meta-algorithmic patterns.

FIG. 2 is a block diagram illustrating one example of a processing system for implementing the system for document classification based on multiple meta-algorithmic patterns.

FIG. 3 is a block diagram illustrating one example of a computer readable medium for document classification based on multiple meta-algorithmic patterns.

FIG. 4 is a flow diagram illustrating one example of a method for document classification based on multiple meta-algorithmic patterns.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Multiple meta-algorithmic patterns are applied to combine multiple summarization engines. The output of the meta-algorithmic patterns are then used as input (in the same way as the output of individual summarization engines) for classification of the documents. Meta-algorithmic summarization engines are themselves combinations of two or more summarization engines; accordingly, they are generally robust to new samples and far better at finding the correct classification within the first few highest ranked classes.

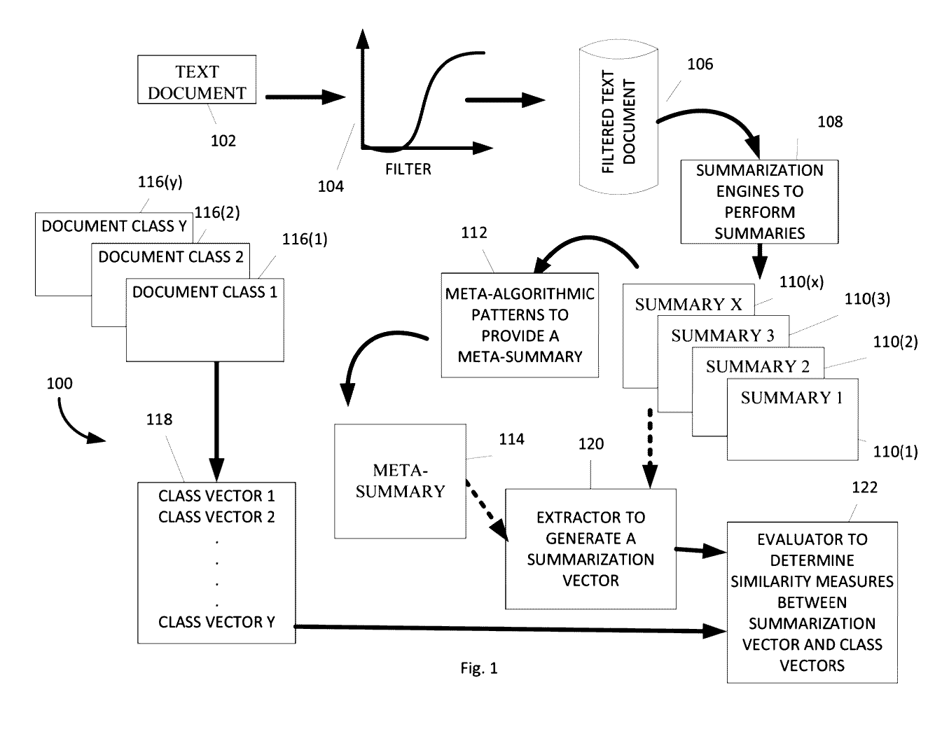

FIG. 1 is a functional block diagram illustrating one example of a system 100 for document classification based on multiple meta-algorithmic patterns. The system receives content, such as a text document, and filters the content. The filtered content is then processed by a plurality of different summarization engines to provide a plurality of summaries. The summaries may be further processed by a plurality of different meta-algorithmic patterns, each meta-algorithmic pattern to be applied to at least two summaries, to provide a meta-summary, where the meta-summary is provided using the at least two summaries. System 100 may treat the meta-summary as a new summary. For example, the meta-summary may be utilized as input for classification in the same way as an output from a summarization engine. The system 100 also identifies at least one class term for each given class of a plurality of classes of documents, the at least one class term extracted from documents in the given class. In one example, a class vector may be generated for each given class of a plurality of classes of documents, the class vector being based on the at least one class term for each given class. The system 100 also extracts at least one summarization term from the meta-summary. In one example, a summarization vector may be generated, the summarization vector being based on the at least one summarization term extracted from the meta-summary.

Similarity measures of the text document over each class of documents of the plurality of classes are determined, each similarity measure indicative of a similarity between the at least one summarization term and the at least one class term for each given class. In one example, the similarity measure may be determined as a cosine similarity between the summarization vector and each class vector. A class of the plurality of classes may be selected, the selection based on the determined similarity measures. The text document may be associated with the selected class of documents. In one example, each summary and/or meta-summary may be associated with a distinct weight determination for each class of documents. An Output Probabilities Matrix may be generated based on such weight determinations, and the classification of the text document may be based on the Output Probabilities Matrix. In one example, the text document may be associated with a class that has an optimal weight determination.

Meta-summaries are summarizations created by the intelligent combination of two or more standard or primary summaries. The intelligent combination of multiple intelligent algorithms, systems, or engines is termed “meta-algorithmics”, and first-order, second-order, and third-order patterns for meta-algorithmics may be defined.

System 100 includes text document 102, a filter 104 filtered text document 106, summarization engines 108, summaries 110(1)-110(x), a plurality of meta-algorithmic patterns 112, a meta-summary 114, an extractor 120, a plurality of classes of documents 116(1)-116(y), class vectors 118 for each given class of the plurality of classes of documents, and an evaluator 122, where “x” is any suitable numbers of summaries and “y” is any suitable numbers of classes and class vectors. Text document 102 may include text, meta-data, and/or other computer storable data, including a book, an article, a document, or other suitable information. Filter 104 filters text document 102 to provide a filtered text document 106 suitable for processing by summarization engines 108. In one example, filter 104 may remove common words (e.g., stop words such as “the”, “a”, “an”, “for”, and “of”) from the text document 102. Filter 104 may also remove blank spaces, images, sound, video and/or other portions of text document 102 to provide a filtered text document 106. In one example, filter 104 is excluded and text document 102 is provided directly to summarization engines 108.

Summarization engines 108 summarize documents in the collection of documents 106 to provide a plurality of summaries 110(1)-110(x). In one example, each of the summarization engines provides a summary including one or more of the following summarization outputs:
(1) a set of key words;
(2) a set of key phrases;
(3) an extractive set of clauses;
(4) an extractive set of sentences;
(5) an extractive set of clustered sentences, paragraphs, and other text chunks; or
(6) an abstractive, or semantic, summarization.

In other examples, a summarization engine may provide a summary including another suitable summarization output. Different statistical language processing (“SLP”) and natural language processing (“NLP”) techniques may be used to generate the summaries.

Meta-algorithmic patterns 112 are used to summarize summaries 110(1)-110(x) to provide a meta-summary 114. Each of the meta-algorithmic patterns is applied to two or more summaries to provide the meta-summary 114. In one example, each of the plurality of meta-algorithmic patterns is based on one or more of the following approaches, as described herein:
(1) Sequential Try Pattern;
(2) Weighted Voting Pattern.
   In other examples, a meta-algorithmic pattern may be based on another suitable approach.

System 100 includes a plurality of document classes 116(1 )-116(y). Class Vectors 118 are based on the plurality of document classes 116(1)-116(y), each class vector associated with each document class, and each class vector based on class terms extracted from documents in a given class. The class terms include terms, phrases and/or summary of representative or “training” documents of the distinct plurality of document classes 116(1)-116(y). In one example, class vector 1 is associated with document class 1, class vector 2 is associated with document class 2, and class vector y is associated with document class y.

The summarization engines and/or meta-algorithmic patterns may be utilized to reduce the text document to a meta-summary that includes summarization terms such as key terms and/or phrases. Extractor 120 generates a summarization vector based on the summarization terms extracted from the meta-summary of the text document. The summarization vector may then be utilized as a means to classify the text document.

Document classification is the assignment of documents to distinct (i.e., separate) classes that optimize the similarity within classes while ensuring distinction between classes. Summaries provide one means to classify documents since they provide a distilled set of text that can be used for indexing and searching. For the document classification task, the summaries and meta-summaries are evaluated to determine the summarization architecture that provides the document classification that significantly matches the training (i.e., ground truth) set. The summarization architecture is then selected and recommended for deployment.

Evaluator 120 determines similarity measures of the text document 102 or the filtered text document 106 over each class of documents of the plurality of classes 116(1)-116(y), each similarity measure being indicative of a similarity between the summarization vector and each respective class vector. The text document may be associated with the document class 116(1)-116(y) for which the similarity between the summarization vector and the class vector is maximized.

In one example, a vector space model (“VSM”) may be utilized to compute the similarity measures, and in this case the similarities of the summarization vector and the class vectors. The vector space itself is an N-dimensional space in which the occurrences of each of N terms (e.g. terms in a query) are the values plotted along each axis, for each of D documents. The vector \vec{d} is the summarization vector of document d, and is represented by a line from the origin to the set of summarization terms for the summarization of document d, while the vector \vec{c} is the class vector for class c, and is represented by a line from the origin to the set of class terms for class c. The dot product of \vec{d} and \vec{c}, or \vec{d}·\vec{c}, is given by

$$\vec{d} \cdot \vec{c} = {\sum }_{w = 1}^{N} {d}_{w} {c}_{w}$$

In one example, the similarity measure between a class vector and the summarization vector may be determined based on the cosine between the class vector and the summarization vector:

$$cos ( \vec{d} , \vec{c} ) = \frac{\vec{d} \cdot \vec{c}}{\vert \vec{d} \vert \vert \vec{c} \vert} = \frac{{\sum }_{w = 1}^{N} {d}_{w} {c}_{w}}{\sqrt{{\sum }_{w = 1}^{N} {d}_{w}^{2}} \sqrt{{\sum }_{w = 1}^{N} {c}_{w}^{2}}}$$

The cosine measure, or normalized correlation coefficient, is used for document categorization. A selector selects a class from the plurality of classes, the selection being based on the determined similarity measures. In one example, the maximum cosine measure over all classes {c} is the class selected by the selector. This approach may be employed for each of the meta algorithmic algorithms described herein in addition to each of the individual summarizers.

(1) The Sequential Try pattern may be employed to classify the text document until one class is selected with a given confidence relative to the other classes. If no classification is obvious after the sequential set of tries is exhausted, the next pattern may be selected, in one example, evaluator 122 computes, for each given class i of documents, a maximum similarity measure of the text document over all classes of documents, not including the given class is In the case where there are N_{classes} of document classes, this may be described as:

max{cos(\vec{d}, \vec{c}ᵢ); j=1 . . . N_{classes}; j≈i}

Evaluator 122 then computes, for each given class i of documents, differences between the similarity measure of the text document over the given class i of documents and the maximum similarity measure, given by:

cos(\vec{d}, \vec{c}ᵢ)−max{cos(\vec{d}, \vec{c}ᵢ); j=1 . . . N_{classes}; j≈i}

Evaluator 122 then determines if a given computed difference of the computed differences satisfies a threshold value, and if it does, selects the class of documents for which the given computed difference satisfies the threshold value. In other words, if the following holds:

cos(\vec{d}, \vec{c}ᵢ)−max{cos(\vec{d}, \vec{c}ᵢ); j=1 . . . N_{classes}; j≈i}>T_{STC}

where T_{STC} is the threshold value for Sequential Try Classification, then the Sequential Try meta-algorithmic pattern terminates and the document is assigned to class i.

In one example, the threshold value T_{STC} may be adjusted based on a confidence in the individual summarizer. For example, a higher confidence may generally be associated with a lower T_{STC} for a classifier. In one example, the threshold value T_{STC} may be adjusted based on the size of the ground truth set. For example, larger ground truth sets allow greater specificity of T_{STC}. In one example, the threshold value T_{STC} may be adjusted based on a number of summarizers to be used in sequence. For example, more summarization engines may generally increase T_{STC} for all classifiers (to avoid including too much content in the overall summarization). Generally, the larger the training data and the larger the number of summarization engines available, the better the final system performance. System performance is optimized, however, when the training data is much larger than the number of summarization engines.

Evaluator 122 may determine that each computed difference does not satisfy the threshold value, and if all the computed differences do not satisfy the threshold value, then the evaluator 122 determines that the Sequential Try meta-algorithmic pattern does not result in a clear classification. In such an instance, a (2) Weighted Voting Pattern may be selected as the meta-algorithmic pattern. Each of the multiple summarizers is tested against a ground truth (training) set of classes, and weighted by one of six methods described herein. In the Weighted Voting meta-algorithmic pattern, the output of multiple summarizers is combined and relatively weighted based on (a) the relative confidence in each engine, and (b) the relative weighting of the terms, phrases, clauses, sentences, chunks, etc, in each summarization.

For the Weighted Voting meta-algorithmic pattern, a weight determination for the individual classifiers may be based on an error rate on the training set, and the evaluator 122 selects, for deployment, the weighted voting pattern based on the weight determination. In one example, freeware, open source and simple summarizers may be combined, by applying appropriate weight determinations, to extract key phrases and/or key words from the text document.

### Optimal Weight Determination Approach:

In one example, with N_{classes} number of classes, to which the a priori probability of assigning a sample is equal, and wherein there are N_{classifiers} number of classifiers, each with its own accuracy in classification of pⱼ, where j=1 . . . N_{classifiers}, the following optimal weight determination may be made:

$${W}_{j} = ln ( \frac{1}{{N}_{classes}} ) + ln ( \frac{{p}_{j}}{{e}_{j}} )$$

where the weight of classifier j is Wⱼ and where the error term eⱼ is given by:

$${e}_{j} = \frac{1 - {p}_{j}}{{N}_{classifiers} - 1}$$

### Inverse-error Proportionality Approach:

In one example, the weights may be proportional to the inverse of the error (inverse-error proportionality approach). In one example, the weights derived from the inverse-error proportionality approach may be normalized—that is, sum to 1.0, and the weight for classifier j may be given by:

$${W}_{j} = \frac{1.0 / ( 1.0 - {p}_{j} )}{{\sum }_{j = 1}^{{N}_{classifiers}} 1.0 / ( 1.0 - {p}_{i} )}$$

### Proportionality to Accuracy Squared Approach:

In one example, the weight determinations may be based on proportionality to accuracy raised to the second power (accuracy-squared) approach. In one example, the associated weights may be described by the following equation:

$${W}_{j} = \frac{{p}_{j}^{2}}{{\sum }_{i = 1}^{{N}_{classifiers}} {p}_{i}^{2}}$$

The inverse-error proportionality approach may favor the relatively more accurate classifiers in comparison to the optimal weight determination approach. The proportionality to accuracy-squared approach may favor the relatively less accurate classifiers in comparison to the optimal weight determination approach. Accordingly, a hybrid method comprising the inverse-error proportionality approach and the proportionality to accuracy-squared approach may be utilized.

### Hybrid Weight Determination Approach:

In the hybrid weight determination approach, a mean weighting of the inverse-error proportionality approach and the proportionality to accuracy-squared approach may be utilized to provide a performance closer to the “optimal” weight determination. In one example, the hybrid weight determination approach may be given by the following equation:

$${W}_{j} - {λ}_{1} \frac{1.0 / ( 1.0 - {p}_{j} )}{{\sum }_{i = 1}^{{N}_{classifiers}} 1.0 / ( 1.0 - {p}_{i} )} + {λ}_{2} \frac{{p}_{j}^{2}}{{\sum }_{i = 1}^{{N}_{classifiers}} {p}_{i}^{2}}$$

where λ₁+λ₂=1.0. Varying the coefficients λ₁ and λ₂ may allow the system to be adjusted for different factors, including accuracy, robustness, lack of false positives for a given class, and so forth.

### Inverse of the Square Root of the Error Approach:

In one example, the weight determinations may be based on an inverse of the square root of the error. The behavior of this weighting approach is similar to the hybrid weight determination approach, as well as the optimal weight determination approach. In one example, the weights may be defined as:

$${W}_{j} = \frac{1.0 / \sqrt{1.0 - {p}_{j}}}{{\sum }_{i = 1}^{{N}_{classifiers}} 1.0 / \sqrt{1.0 - {p}_{i}}}$$

After the individual weights are determined, classification assignment may be given to the class with the highest weight. In one example, evaluator 122 performs the classification assignment. In one example, the highest weight may be determined as:

$$Classification = {max}_{i} {\sum }_{j = 1}^{{N}_{c}} {ClassifierWeight}_{j} * {ClassWeight}_{i , j}$$

where N_{C} is the number of classifiers, i is the index for the document classes, j is the index for the classifier, ClassWeightᵢⱼ is the confidence each particular classifier j has for the class i, and ClassifierWeightⱼ is the weight of classifier j based on the weight determination approaches described herein.

An example classification assignment is illustrated in Table 1. The example illustrates a situation with two classifiers A and B, and four classes C₁, C₂, C₃, and C₄. The confidence in classifier A, ClassifierWeight_{A}, may be 0.6 and the confidence in classifier B, ClassifierWeight_{B}, may be 0.4. Such confidence may be obtained based on the weight determination approaches described herein. In this example, classifier A assigns weights ClassWeight_{1,A}=0.3, ClassWeight_{2,A}=0.4, ClassWeight_{3,A}=0.1, and ClassWeight_{4,A}=0.2 to each of classes C₁, C₂, C₃, and C₄, respectively. Also, for example, classifier B assigns weights ClassWeight_{1,B}=0.5, ClassWeight_{2,B}=0.3, ClassWeight_{3,B}=0.2, and ClassWeight_{4,B}=0.0 to each of classes C₁, C₂, C₃, and C₄, respectively. Then the weight assignment for each class may be obtained as illustrated in Table 1.

TABLE 1
Classification Assignment based on Weight Determination

| | | ClassWeightᵢⱼ, j = A, B, i = 1, 2, 3, 4. | | | |
|---|---|---|---|---|---|
| Classifer | ClassifierWeightⱼ, j = A, B | C₁ | C₂ | C₃ | C₄ |
| A | ClassifierWeight_{A} = 0.6 | 0.3 | 0.4 | 0.1 | 0.2 |
| B | ClassifierWeight_{B} = 0.4 | 0.5 | 0.3 | 0.2 | 0.0 |

| | | | | |
|---|---|---|---|---|
| $\begin{matrix}Weight Assignment for each Class i = \\ {\sum }_{j = A , B} {ClassifierWeight}_{j} * {ClassWeight}_{i , j}\end{matrix}$ | (0.6)*(0.3) + (0.4)*(0.5) = 0.38 | (0.6)*(04) + (0.4)*(0.3) = 0.36 | (0.6)*(0.1) + (0.4)*(0.2) = 0.14 | (0.6)*(0.2) + (0.4)*(0.0) = 0.12 |

Accordingly,

$${max}_{i} {\sum }_{j = 1}^{{N}_{c}} {ClassifierWeight}_{j} * {ClassWeight}_{i , j} = max ( 0.38 , 0.36 , 0.14 , 0.12 ) = 0.38 .$$

In this example, the maximum weight assignment of 0.38 corresponds to class C₁. Based on such a determination, the evaluator 122 selects class C₁ for classification.

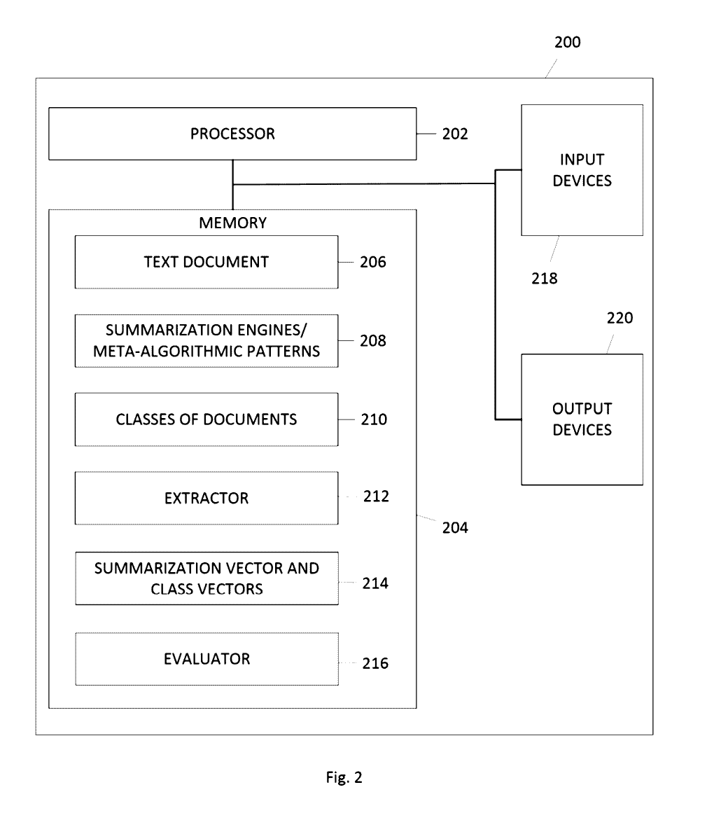

FIG. 2 is a block diagram illustrating one example of a processing system 200 for implementing the system 100 for document classification based on multiple meta-algorithmic patterns. Processing system 200 includes a processor 202, a memory 204, input devices 218, and output devices 220. Processor 202, memory 204, input devices 218, and output devices 220 are coupled to each other through communication link (e.g., a bus).

Processor 202 includes a Central Processing Unit (CPU) or another suitable processor. In one example, memory 204 stores machine readable instructions executed by processor 202 for operating processing system 200. Memory 204 includes any suitable combination of volatile and/or non-volatile memory, such as combinations of Random Access Memory (RAM), Read-Only Memory (ROM), flash memory, and/or other suitable memory.

Memory 204 stores text document 206, and a plurality of classes of documents 210 for processing by processing system 200. Memory 204 also stores instructions to be executed by processor 202 including instructions for summarization engines and/or meta-algorithmic patterns 208, an extractor 212, and an evaluator 216. Memory 204 also stores the summarization vector and class vectors 214. In one example, summarization engines and/or meta-algorithmic patterns 208, extractor 212, and evaluator 216, include summarization engines 108, meta-algorithmic patterns 112, extractor 120, and evaluator 122, respectively, as previously described and illustrated with reference to FIG. 1.

In one example, processor 202 executes instructions of filter to filter a text document to provide a filtered text document 206. Processor 202 executes instructions of a plurality of summarization engines and/or meta-algorithmic patterns 208 to summarize the text document 206 to provide a meta-summary. In one example, the plurality of summarization engines and/or meta-algorithmic patterns 208 may include a sequential try pattern, followed by a weighted voting pattern, as described herein. Processor 202 executes instructions of extractor 212 to generate at least one summarization term from the meta-summary of the text documents 206. In one example, a summarization vector may be generated based on the at least one summarization term extracted from the meta-summary. In one example, processor 202 executes instructions of extractor 212 to generate at least one class term for each given class of a plurality of classes of documents 210, the at least one class term extracted from documents in the given class. In one example, a class vector may be generated for each given class of a plurality of classes of documents 210, the class vector being based on the at least one class term extracted from documents in the given class. Processor 202 executes instructions of evaluator 216 to determine the similarity measures of the text document 206 over each class of documents of the plurality of classes 210, each similarity measure indicative of a similarity between the at least one summarization term and the at least one class term for each given class. In one example, the similarity measures may be based on cosine similarity between the summarization vector and each class vector. In one example, processor 202 executes instructions of a selector to select a class of the plurality of classes, the selection based on the determined similarity measures. In one example, processor 202 executes instructions of a selector to associate, in a database, the text document with the selected class of documents.

Input devices 218 include a keyboard, mouse, data ports, and/or other suitable devices for inputting information into processing system 200. In one example, input devices 218 are used to input feedback from users for evaluating a text document, an associated meta-summary, and/or an associated class of documents, for search queries. Output devices 220 include a monitor, speakers, data ports, and/or other suitable devices for outputting information from processing system 200. In one example, output devices 220 are used to output summaries and meta-summaries to users and to recommend a classification for the text document. In one example, a classification query directed at a text document is received via input devices 218. The processor 202 retrieves, from the database, a class associated with the text document, and provides such classification via output devices 220.

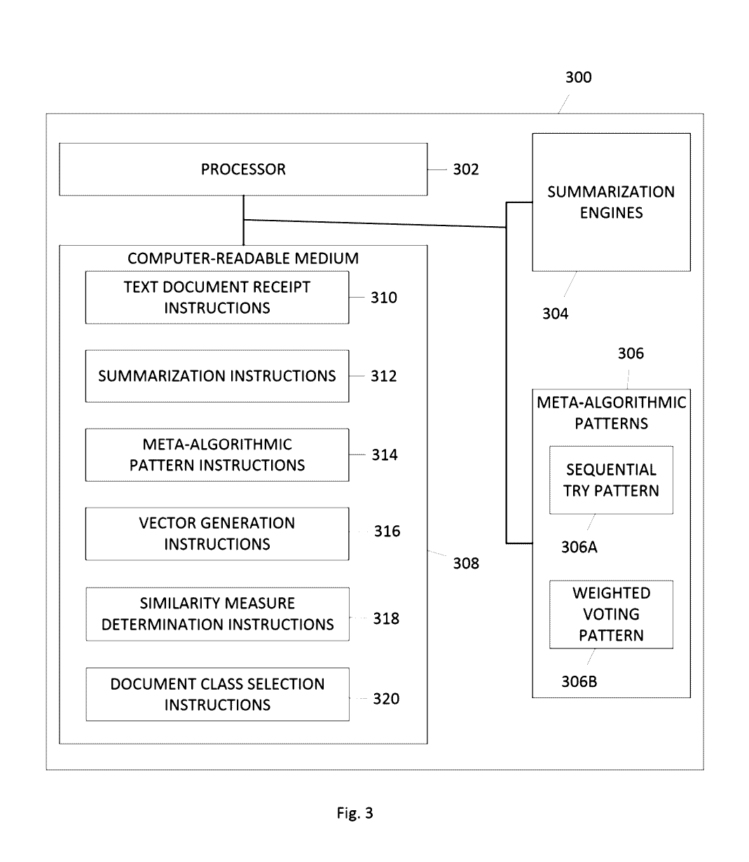

FIG. 3 is a block diagram illustrating one example of a computer readable medium for document classification based on multiple meta-algorithmic patterns. Processing system 300 includes a processor 302, a computer readable medium 308, a plurality of summarization engines 304, and a plurality of meta-algorithmic patterns 306. In one example, the plurality of meta-algorithmic patterns 306 include the Sequential Try Pattern 306A and the Weighted Voting Pattern 306B. Processor 302, computer readable medium 308, the plurality of summarization engines 304, and the plurality of meta-algorithmic patterns 306 are coupled to each other through communication link (e.g., a bus).

Processor 302 executes instructions included in the computer readable medium 308. Computer readable medium 308 includes text document receipt instructions 310 to receive a text document. Computer readable medium 308 includes summarization instructions 312 of a plurality of summarization engines 304 to summarize the received text document to provide summaries. Computer readable medium 308 includes meta-algorithmic pattern instructions 314 of a plurality of meta-algorithmic patterns 306 to summarize the summaries to provide a meta-summary. Computer readable medium 308 includes vector generation instructions 316 of extractor to generate a summarization vector based on summarization terms extracted from the meta-summary. Computer readable medium 308 includes vector generation instructions 316 of extractor to generate a class vector for each given class of a plurality of classes, the class vector being based on class terms extracted from documents in the given class. Computer readable medium 308 includes similarity measure determination instructions 318 of evaluator to determine similarity measures of the text document over each class of documents of the plurality of classes, each similarity measure indicative of a similarity between the summarization vector and each class vector. Computer readable medium 308 includes document class selection instructions 320 of selector to select a class of the plurality of classes, the selecting based on the determined similarity measures. In one example, computer readable medium 308 includes instructions to associate the selected class with the text document.

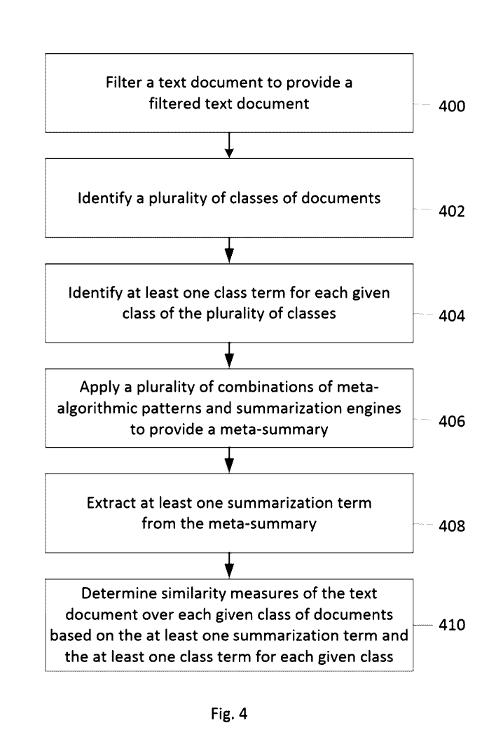

FIG. 4 is a flow diagram illustrating one example of a method for document classification based on multiple meta-algorithmic patterns. At 400, a text document is filtered to provide a filtered text document. At 402, a plurality of classes of documents are identified. At 404, at least one class term is identified for each given class of the plurality of classes of documents. At 406, a plurality of combinations of meta-algorithmic patterns and summarization engines are applied to provide a meta-summary of the filtered text document. At 408, at least one summarization term is extracted from the meta-summary. At 410, similarity measures of the text document over each class of documents of the plurality of classes are determined, each similarity measure indicative of a similarity between the at least one summarization term and the at least one class term for each given class.

In one example, the method may include selecting a class of the plurality of classes, the selecting based on the determined similarity measures.

In one example, the method may include associating, in a database, the text document with the selected class of documents.

In one example, the meta-algorithmic pattern may be a sequential try pattern, and the method may include determining that one of the similarity measures satisfies a threshold value, selecting a given class of the plurality of classes for which the determined similarity measure satisfies the threshold value, and associating the text document with the given class. In one example, the method may further include determining that each of the similarity measures fails to satisfy the threshold value, and selecting a weighted voting pattern as the meta-algorithmic pattern.

Examples of the disclosure provide a generalized system for using multiple summaries and meta-algorithms to optimize a text-related intelligence generating or machine intelligence system. The generalized system provides a pattern-based, automatable approach to document classification based on summarization that may learn and improve over time, and is not fixed on a single technology or machine learning approach. In this way, the content used to represent a larger body of text, suitable to a wide range of applications, may be classified.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a plurality of summarization engines, each summarization engine to receive, via a processing system, a text document to provide a summary of the text document;
a plurality of meta-algorithmic patterns, each meta-algorithmic pattern to be applied to at least two summaries to provide, via the processing system, a meta-summary of the text document using the at least two summaries;
at least one class term for each given class of a plurality of classes of documents, the at least one class term extracted from documents in the given class;
an extractor to extract at least one summarization term from the meta-summary; and
an evaluator to determine similarity measures of the text document over each given class of documents of the plurality of classes, each similarity measure indicative of a similarity between the at least one summarization term and the at least one class term for each given class.

2. The system of claim 1, further comprising a selector to select a class of the plurality of classes, the selection based on the determined similarity measures.

3. The system of claim 2, wherein the selector associates, in a database, the text document with the selected class of documents.

4. The system of claim 1, wherein the meta-algorithmic pattern is a sequential try pattern, and the evaluator:
computes, for each given class of documents, a maximum similarity measure of the text document over all classes of documents, not including the given class,
computes, for each given class of documents, differences between the similarity measure of the text document over the given class of documents and the maximum similarity measure;
determines if a given computed difference of the computed differences satisfies a threshold value, and if it does, selects the class of documents for which the given computed difference satisfies the threshold value.

5. The system of claim 4, wherein the threshold value is based on a confidence in a summarization engine, a confidence in a meta-algorithmic pattern, a number of summarization engines, a number of meta-algorithmic patterns, and a size of a ground truth set.

6. The system of claim 4, wherein the evaluator determines if each computed difference does not satisfy the threshold value, and if all the computed differences do not satisfy the threshold value, then a weighted voting pattern is selected as the meta-algorithmic pattern.

7. The system of claim 6, wherein a weight determination for the weighted voting pattern is based on an error rate on a training set, and the evaluator selects, for deployment, the weighted voting pattern based on the weight determination.

8. A method to classify a text document based on meta-algorithm patterns, the method comprising:
filtering the text document to provide a filtered text document;
identifying a plurality of classes of documents via a processor;
identifying at least one class term for each given class of the plurality of classes of documents, the at least one class term extracted from documents in the given class;
applying, to the filtered text document, a plurality of combinations of meta-algorithmic patterns and summarization engines, wherein:
each summarization engine provides a summary of the filtered text document, and
each meta-algorithmic pattern is applied to at least two summaries to provide, via the processor, a meta-summary;
extracting at least one summarization term from the meta-summary; and
determining similarity measures of the text document over each given class of documents of the plurality of classes, each similarity measure indicative of a similarity between the at least one summarization term and the at least one class term for each given class.

9. The method of claim 8, further including selecting a class of the plurality of classes, the selecting based on the determined similarity measures.

10. The method of claim 9, further including associating, in a database, the text document with the selected class of documents.

11. The method of claim 8, wherein the meta-algorithmic pattern is a sequential try pattern, and further including:
determining that one of the similarity measures satisfies a threshold value;
selecting a given class of the plurality of classes for which the determined similarity measure satisfies the threshold value; and
associating the text document with the given class.

12. The method of claim 11, further including:
determining that each of the similarity measures fails to satisfy the threshold value; and
selecting a weighted voting pattern as the meta-algorithmic pattern.

13. A non-transitory computer readable medium comprising executable instructions to:
receive a text document via a processor;
apply a plurality of combinations of meta-algorithmic patterns and summarization engines, wherein:
each summarization engine provides a summary of the text document, and
each meta-algorithmic pattern is applied to at least two summaries to provide, via the processor, a meta-summary;
extract at least one summarization term from the meta-summary;
generate at least one class term for each given class of a plurality of classes of documents, the at least one class term extracted from documents in the given class;
determine similarity measures of the text document over each given class of documents of the plurality of classes, each similarity measure indicative of a similarity between the at least one summarization term and the at least one class term for each given class; and
select a class of the plurality of classes, the selecting based on the determined similarity measures.

14. The non-transitory computer readable medium of claim 13, wherein the meta-algorithmic pattern is a sequential try pattern, and comprising executable instructions to:
determine that one of the similarity measures satisfies a threshold value;
select a given class of the plurality of classes for which the determined similarity measure satisfies the threshold value; and
associate the text document with the given class.

15. The non-transitory computer readable medium of claim 14, comprising executable instructions to:
determine that each of the similarity measures fails to satisfy the threshold value; and
select a weighted voting pattern as the meta-algorithmic pattern.
